(19) United States
(12) Patent Application Publication
(10) Pub. No.: US 2024/0278203 A1
(43) Pub. Date: Aug. 22, 2024

(54) MANUAL DEVICES AND SYSTEMS FOR MIXING OR SEPARATING COMPONENTS OF A SOLUTION

(71) Applicant: Georgia Tech Research Corporation, Atlanta, GA (US)

(72) Inventors: Constance Pauline Norris Squirrel, Atlanta, GA (US); Wendell Wilson, Atlanta, GA (US); Mixuan Li, Atlanta, GA (US)

(73) Assignee: Georgia Tech Research Corporation, Atlanta, GA (US)

(21) Appl. No.: 18/111,301

(22) Filed: Feb. 17, 2023

(51) Int. Cl. B01F 35/32; B01F 35/33; B04B 9/08

(52) U.S. Cl. CPC B01F 35/3202; B01F 35/3212; B01F 35/33; B04B 9/08; B01F 2101/23

(57) ABSTRACT

This disclosure is directed to manual devices or systems for mixing or separating components of a solution. The manual devices or systems include a body and an actuator movably coupled to the body that can be manually actuated by a user. The manual devices and systems include a coupling rotatably coupled to the body. A mounting mounts to the coupling to hold a container filled with a solution. The manual devices and systems include a transmission operatively connected to the actuator and to the coupling. The transmission transmits a manual force from the actuator to the coupling to rotate the coupling and the mounting and mix or separate components within the solution. The manual force applied to the actuator and transmitted to the coupling by the transmission is the only force actively applied by the manual device to the coupling to rotate the coupling.

### FIELD OF THE INVENTION

The present disclosure generally relates to manual devices and systems for mixing or separating components of a solution, and for example devices that mix or separate the components of the solution exclusively using manual power.

### BACKGROUND

Some laboratory procedures can involve vigorous mixing of solutions, which can sometimes but not always include forming a vortex in the solution. Some laboratory procedures can involve separating components of solutions into constituent parts. Separating components into constituent parts can sometimes but not always include centrifuging the solutions.

Some existing devices that mix or separate components of a solution, such as for example laboratory devices, are driven by motors powered by electricity or other fuel sources. But such devices driven by motors powered by electricity or other fuel sources are not advantageous in some settings. For example, some procedures that require mixing or separating components of a solution are performed in locations without reliable electric grids. Intermittent power failures and/or insufficient capacity caused by such unreliable electric grids can interrupt or delay the mixing or separating of the components of the solution, which can compromise the efficacy of some procedures. Uninterruptible power sources, such as an internal battery or functional equivalent, can be integrated into devices that mix or separate components of a solution to address problems caused by intermittent power failures. But integrating uninterruptable power sources into devices that mix or separate components of a solution can add complexity, size, and cost.

### SUMMARY

The inventors recognize a need for devices that mix or separate components of a solution that do not rely on electric grids, uninterruptible power sources, or other fuel sources and that perform at levels comparable to performance of existing powered vortexes and centrifuges.

The foregoing needs are met by the manual devices and systems of the present disclosure. According to one aspect of the present disclosure, a manual system includes

Another general aspect of this disclosure is a manual device that includes a body and an actuator that is configured to be manually actuated by a user. The system also includes a coupling and a mounting that is configured to mount to the coupling and that is configured to hold a container filled with a solution. The system also includes a transmission within the body and operatively connected to the actuator and to the coupling. When the coupling is connected to the mounting, when the mounting holds the container filled with the solution, and when the actuator is actuated by the user, the transmission transmits a manual force from the actuator to the coupling to rotate the coupling and the mounting and one of mix components of the solution or separate the components of the solution. The manual force applied to the actuator and transmitted to the coupling by the transmission is the only force actively applied by the manual system to the coupling to rotate the coupling.

Implementations may include one or more of the following features. The manual system includes no electric motor that is configured to rotate the coupling. The mounting is removably connected to the coupling. The mounting is a mixing mounting, and the manual system may further include a separating mounting that is interchangeable with the mixing mounting. The separating mounting is configured to hold the container filled with the solution and when the coupling is connected to the separating mounting, when the separating mounting holds the container filled with the solution, and when the actuator is actuated by the user, the transmission transmits the manual force from the actuator to the coupling to rotate the coupling and separate the components of the solution. The actuator is configured to impart a linear force of the manual force to the transmission, and the transmission is configured to convert the linear force to a rotational force. The actuator is configured to move between a first position and a second position, and a movement of the actuator from the first position to the second position inputs the manual force into the manual system. The actuator may include a spring that biases the actuator in the first position. The transmission may include a gear train. The transmission may include a belt.

Another general aspect includes a manual device that includes a body and an actuator that is configured to be manually actuated by a user. The device also includes a coupling configured to mount a mounting that holds a container filled with a solution. The device also includes a transmission within the body and operatively connected to the actuator and to the coupling. When the coupling is connected to the mounting, when the mounting holds the container filled with the solution, and when the actuator is actuated by the user, the transmission transmits a manual force from the actuator to the coupling to rotate the coupling and the mounting and one of mix components of the solution or separate the components of the solution. The manual force applied to the actuator and transmitted to the coupling by the transmission is the only force actively applied by the manual device to the coupling to rotate the coupling.

Implementations may include one or more of the following features. The manual device where the manual device includes no electric motor that is configured to rotate the coupling. The coupling is configured to removably mount the mounting. The mounting is a mixing mounting, and the coupling is configured to interchangeably mount the mixing mounting and a separating mounting. The separating mounting is configured to hold the container filled with the solution and when the coupling mounts the separating mounting, when the separating mounting holds the container filled with the solution, and when the actuator is actuated by the user, the transmission transmits the manual force from the actuator to the coupling to rotate the coupling and the separating mounting and performs a centrifuge of the solution. The actuator is configured to impart a linear force of the manual force to the transmission, and the transmission is configured to convert the linear force to a rotational force. The actuator is configured to move between a first position and a second position, and a movement of the actuator from the first position to the second position inputs the manual force into the manual device. The actuator may include a spring that biases the actuator in the first position. The transmission may include a gear train. The transmission may include a belt.

There has thus been outlined certain embodiments of the present disclosure in order that the detailed description thereof herein may be better understood, and in order that the present contribution to the art may be better appreciated. There are additional embodiments of the present disclosure that will be described below, and that form the subject matter of the claims appended hereto.

In this respect, before explaining at least one aspect of the present disclosure in detail, it is to be understood that the embodiments described herein are not limited in their application to the details of construction and to the arrangements of the components set forth in the following description or illustrated in the drawings. The system and device of this disclosure are capable of aspects in addition to those described, and of being practiced and carried out in various ways.

### BRIEF DESCRIPTION OF THE DRAWINGS

In order that the present disclosure may be readily understood, aspects are illustrated by way of examples in the accompanying drawings, in which like parts are referred to with like reference numerals throughout.

FIG. 1 shows a schematic representation of a manual system for mixing or separating components of a solution.

FIG. 2 shows a perspective view of a manual system for mixing or separating components of a solution.

FIG. 3 shows a perspective cross section view of the manual system of FIG. 2.

FIG. 4 shows a perspective view of a manual system for mixing or separating components of a solution.

FIG. 5 shows a perspective cross section view of the manual system of FIG. 4.

FIG. 6 shows a perspective view of a mixing mounting.

FIG. 7 shows a perspective view of another mixing mounting.

FIG. 8 shows a perspective view of yet another mixing mounting.

FIG. 9 shows a perspective view of a separating mounting.

### DETAILED DESCRIPTION

The present disclosure is directed to manual devices and systems that can mix or separate components of a solution. The manual devices and systems of this disclosure can operate exclusively on manual power and as such are immune from the negative consequences of intermittent electrical grid failures and from the integration of uninterruptable power sources such as batteries. Manual power as used herein, can include the plain and ordinary meaning and can mean that the energy input into the devices and systems to mix or separate the components of the solution can be supplied exclusively by humans without assistance from motors (or functionally equivalent mechanical devices) driven by electricity or other fuel sources. Put differently, the manual devices and systems of this disclosure do not include any motors (or functionally equivalent mechanical devices) powered by energy sources such as electricity or other fuels that power the mixing or separating of the components in the solution.

The manual devices and systems of this disclosure do not require the added size, complexity, and expense necessary to implement uninterruptable power sources such as batteries or fuel.

The manual devices and systems of this disclosure can perform similarly to existing vortexes and centrifuges powered by electrical power (or some other fuel source). For example, the manual devices and systems of this disclosure can mix solutions at similar speeds and to similar homogeneity levels as existing vortexes and centrifuges powered by electrical power (or some other fuel source).

The manual devices and systems of this disclosure can mix or separate components of a solution without requiring direct user contact with the solution. For example, the solution can be contained within a container that is sealed off from the external environment during the mixing or separating of the components of the solution performed by the manual devices and systems of this disclosure.

Additionally, the manual devices and systems of this disclosure can include interchangeable mountings such that the same manual device can be alternately configured to mix the components of the solution or separate the components of the solution depending on which mounting is attached to the manual device. The manual devices and systems of this disclosure can be compatible with containers of different sizes to allow for mixing or separating of components of different amounts of solutions.

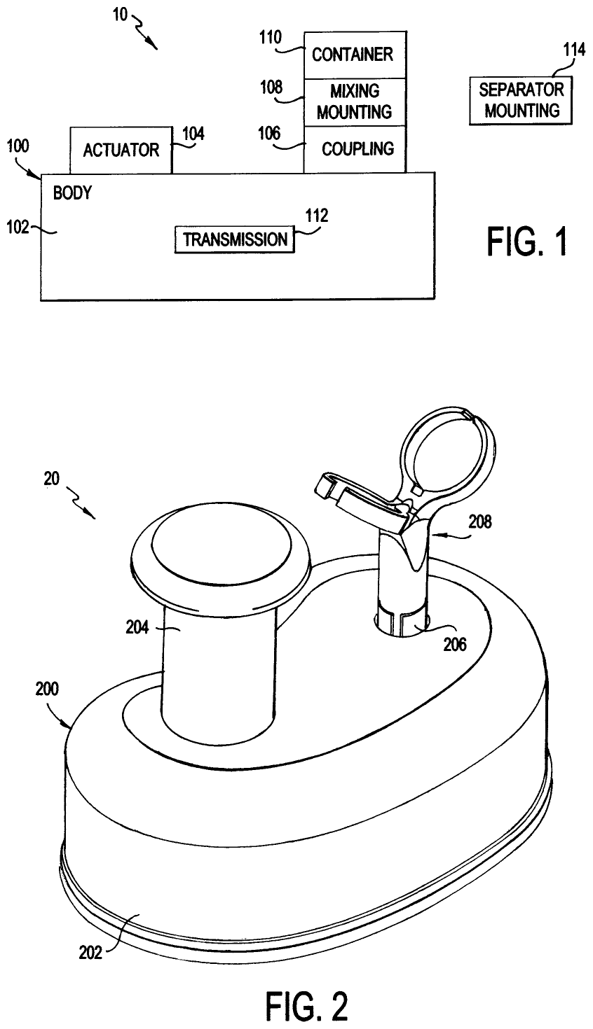

These and other aspects can apply to the embodiments of this disclosure shown in FIGS. 1-3 and described as follows.

FIG. 1 shows a perspective view of a manual system 10 for mixing or separating components of a solution according to aspects of this invention. The term “manual,” as used throughout this disclosure can include the plain and ordinary meaning of the term, and can include work performed by any portion of a person including by hand, foot, arm, other appendage, among possibilities. The term “solution,” as used herein, can include the plain and ordinary meaning of the term and can at least mean two or more substances at least one of which is in a liquid or semi-liquid state. The manual system 10 can include a manual device 100 that can function exclusively on manual power, as described previously. The manual device 100 can include a body 102. The body 102 can house various components of the manual device 100. The body 102 can be formed of any number of materials including for example ABS, neoprene rubber, thermoplastic elastomer, combinations thereof, etc. In embodiments, the body 102 can be ergonomically shaped. In embodiments, the body 102 can include attachments (e.g., silicon attachments) at the bottom of the body 102, which can increase the friction between the body 102 and a surface that the body 102 rests on to reduce or prevent slippage of the manual device 100 during use.

The manual device 100 can include an actuator 104. The actuator 104 can be movably coupled to the body 102 and can be manually actuated by a user. In embodiments, the actuator 104 can be movable between a first position and a second position. For example, a user can actuate the actuator 104 by moving the actuator from the first position to the section position to input a manual force into the manual device 100. The actuator 104 can be biased in the first position by a spring or other functionally equivalent component. By biasing the actuator 104 in the first position, the actuator 104 can automatically rest after a user moves the actuator 104 from the first position to the second position to input the manual force thereby automatically resting the actuator 104 for subsequent inputs of manual force. In embodiments, the actuator 104 can be a button, a pump, a lever, a handle, a pull string, a hand crank, a wheel, combinations thereof, or other functional equivalents. In embodiments, the actuator can be covered with non-slip lining such as for example silicon.

In embodiments, the actuator 104 can include a clutch or functional equivalent mechanical connection or structure. The clutch can operatively connect the actuator 104 to the transmission 112 when the actuator 104 is moved from the first position to the second position to input the manual force into the manual device 100. The clutch can operatively disconnect the actuator 104 and the transmission 112 when the actuator 104 resets from the second position to the first position. According to this configuration, the actuator 104 can be reset without interfering with the transmission 112. In embodiments, the clutch can be defined by the geometry of a connection between the actuator 104 and the transmission 112.

The manual device 100 can include a coupling 106. The coupling 106 can be rotatably coupled to the body 102. The coupling 106 can include a connector. In embodiments, the coupling 106 can be covered with a liner, such as a silicon liner.

The manual system 10 can include a mounting that can mount to the coupling 106. The mounting can include a connector that is complementary to the connector of the coupling 106 such that the connector of the mounting can connect with the connector of the coupling 106. The connector of the mounting can form a connection with the connector of the coupling 106 that causes the mounting to rotate together with the coupling 106 when the coupling 106 is rotated. The connection formed by the connector of the mounting and the connector of the coupling 106 can be a removable connection, or alternatively can be a fixed connection. The connection formed by the connector of the mounting and the connector of the coupling 106 can have sufficient strength to maintain a connection between the connector of the mounting and the connector of the coupling 106 during either or both of mixing or separating the components of the solution by the manual device 100. In embodiments the connectors of the coupling 106 and/or the mounting can include threads, shapes, recesses, snap fits, spring-loaded bearings, combinations thereof, and other functional equivalents. In embodiments, the mounting can mix components of a solution held within the container 110 independently from the manual device 100. For example, a user can hold the mounting directly and manually mix the components of the solution by imparting orbital motion to the mounting.

In embodiments, the mounting can be a mixing mounting 108, which can hold a container 110 that contains a solution in a manner that causes components of the solution to mix together when the mixing mounting 108 is rotated by the coupling 106. For example, in embodiments the mixing mounting 108 can generate a vortex to mix components of the solution when the mixing mounting 108 is rotated by the coupling 106. In embodiments, the mixing mounting 108 can mix components of the solution when the mixing mounting 108 is rotated by the coupling 106 without generating a vortex within the solution.

In embodiments, the mounting can be a separating mounting 114, which can hold the container 110 containing the solution in a manner that causes components in the solution to separate when the separating mounting 114 is rotated by the coupling 106. For example, in embodiments the separating mounting 114 can generate a centrifuge that causes the components in the solution to separate when the separating mounting 114 is rotated by the coupling 106. In embodiments, the separating mounting 114 can separate components within the solution when the separating mounting 114 is rotated by the coupling 106 without performing a centrifuge.

In embodiments, the manual system 10 can include both the mixing mounting 108 (e.g., a first mounting) and the separating mounting 114 (e.g., a second mounting). In such embodiments, each of the mixing mounting 108 and the separating mounting 114 can include connectors that can respectively be removably attached to the coupling 106. This can allow the manual device 100 to both mix the components of the solution and separate the components of the solution, depending on which of the mixing mounting 108 and the separating mounting 114 is connected to the coupling 106.

The manual device 100 can include a transmission 112. The transmission 112 can be provided within the body 102. The transmission 112 can be operatively connected to each of the actuator 104 and the coupling 106. The transmission 112 can transmit the manual force exerted on the actuator 104 by the user to the coupling 106 to rotate the coupling 106. Rotation of the coupling 106 can mix the components within the solution or separate the components within the solution depending upon which of the mixing mounting 108 and the separating mounting 114 is holding the container 110 that contains the solution. In embodiments, the transmission 112 can convert the manual force exerted on the actuator 104 to rotate the coupling 106. For example, in embodiments the transmission 112 can convert a linear manual force that moves the actuator 104 from the first position to the second position to a rotational force to rotate the coupling 106.

The manual force applied by the user to the actuator 104 and transmitted through the transmission 112 can be the only force that is actively applied by the manual device 100 to the coupling 106 to rotate the coupling 106 and thereby mix or separate the components within the solution. Actively applied can mean that the manual force is the only force controlled by or transmitted through the manual device 100 that is applied to the coupling 106 to rotate the coupling 106, though other incidental forces (e.g., gravity, inertial forces caused by moving the device, etc.) can from time to time unintentionally case rotation of the coupling 106. In any event, the manual system 10 and the manual device 100 can each be provided without any motor (electric motor or motor powered by any other energy source other than force exerted by a user) such the manual force applied by the user to the actuator 104 and transmitted through the transmission 112 can be the only force that is actively applied by the manual device 100 to the coupling 106 to rotate the coupling 106 and thereby mix or separate the components within the solution.

In embodiments, the transmission 112 can include any combination of gears, shafts, springs, wheels, cables, bearings, belts, hydraulics, or functional equivalents. In embodiments, the transmission 112 can be formed of any number of materials such as for example, nylon, PTFE, stainless steel, combinations thereof, etc.

FIG. 2 shows a perspective view of a manual system 20 according to aspects of this invention. FIG. 3 shows a cross-section view of the manual system 20. With the exception of features that persons of ordinary skill in the art would clearly recognize as mutually exclusive features, the manual system 20 can include any of the features of the manual system 10, described previously, and vice versa. For example, the manual system 20 can include a manual device 200, a body 202, an actuator 204, a coupling 206, a mixing mounting 208, and a transmission 212 that can include any of the features previously described in reference to like parts identified with like reference numerals of the manual system 10. Additionally, though not shown in FIGS. 2 and 3, the manual system 20 can include and/or be used together with the container 110 and the separating mounting 114 in the manner previously described in reference to like parts of the manual system 10.

The actuator 204 of the manual device 200 can include a pump 216, which can be depressed by a user at least partially into the body 202 to input the manual force to the transmission 212, as previously described. The actuator 204 can include a spring 218 (shown schematically in FIG. 3). The spring 218 can bias the pump 216 in the first position, as previously described.

The transmission 212 can include a gear train 220 than can be coupled to shafts 222 such that the gear train 220 and the shafts 222 can rotate together. The shafts 222 can be rotatably coupled to the body 202. The transmission 212 can include a hood 224, which can be operatively coupled to the pump 216 and rotatably coupled to the body 202. For example, the hood 224 can be operatively coupled to the pump 216 such that when the pump 216 is moved by a user from the first position to the second position the pump 216 imparts a linear force of the manual force to the hood 224. The hood 224 can convert the linear force of the manual force into a rotational force of the manual force, which rotates about a central axis of the hood 224. For example, the pump 216 and the hood 224 can include complimentary spiral threads that can convert the linear force imparted on the pump 216 to a rotational force of the hood 224. In embodiments, a clutch can be provided between the pump 216 and the hood 224, as previously described.

The hood 224 can include a connector 226, such as for example a spool. A shaft 222 can include a connector 228, such as for example a spool. The transmission 212 can include a belt 230 (or chain or another functional equivalent). The belt 230 be rotatably connected to each of the connector 226 and the connector 228. According to this configuration, when the manual force is converted to rotational force the hood 224 can drive the belt 230 via the connector 226 to transmit the rotational force to the connector 228 and thereby rotationally drive the gear train 220. A shaft 222 can be connected to the coupling 206 and the gear train 220 can rotationally drive the coupling 206 via the shaft 222. The coupling 206 can be connected to the mixing mounting 208 and when rotated can mix the components within the solution held within a container that is held by the mixing mounting 208, as previously described.

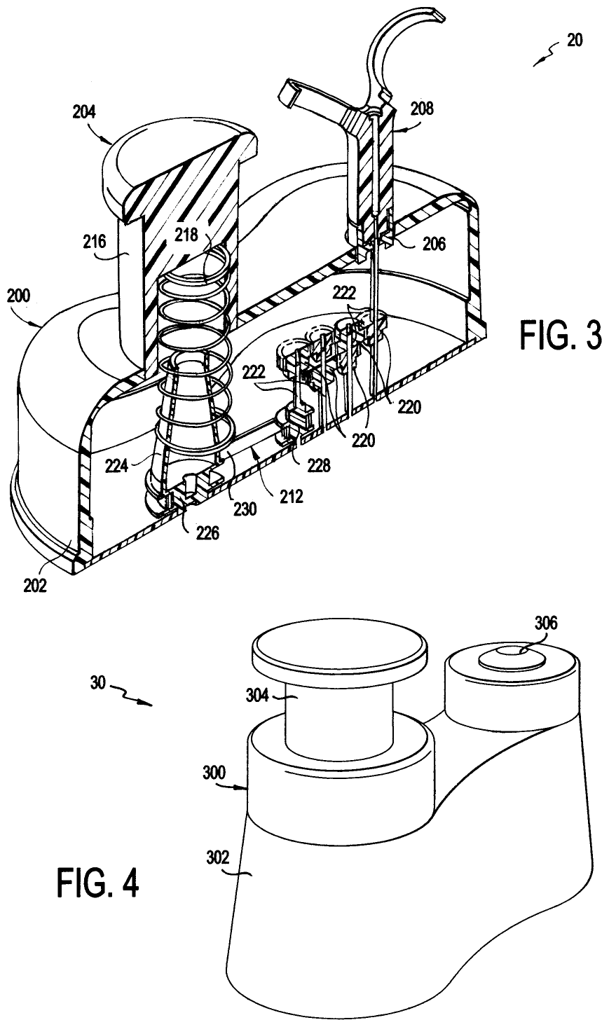

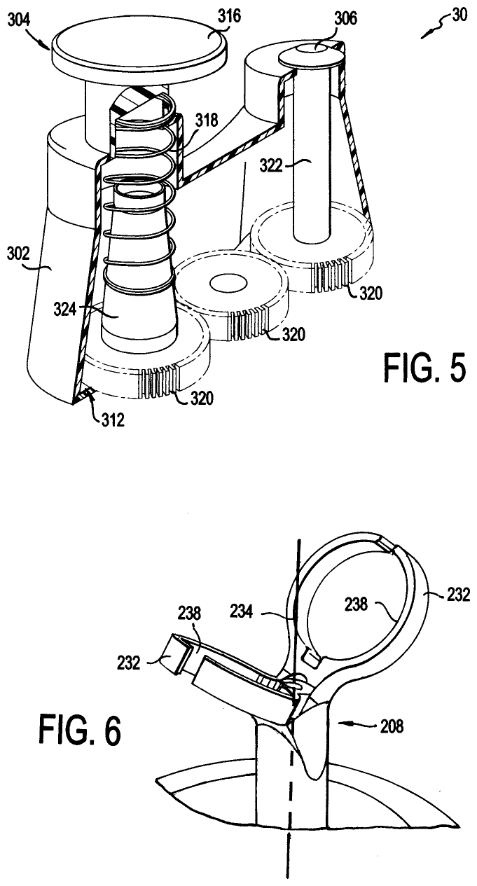

FIG. 4 shows a perspective view of a manual system 30 for mixing or separating components of a solution. FIG. 5 shows perspective cross section view of the manual system 30 of FIG. 4. With the exception of features that persons of ordinary skill in the art would clearly recognize as mutually exclusive features, the manual system 30 can include any of the features of the manual systems 10 and/or 20, described previously, and vice versa. For example, the manual system 30 can include a manual device 300, a body 302, an actuator 304, a coupling 306 that can include a pump 316 and a spring 318, and a transmission 312 that can include a gear train 320, one or more shafts 322, and a hood 324. Such structures can include any of the features previously described in reference to like parts identified with like reference numerals of the manual systems 10 and/or 20. Additionally, though not shown in FIGS. 4 and 5, the manual system 30 can include and/or be used together with the container 110, the mixing mounting 108, and the separating mounting 114 in the manner previously described in reference to like parts of the manual system 10.

The gear train 320 of the manual device 300 can be directly and rotationally connected to each of the hood 324 and a shaft 322 fixed to the coupling 306. In such embodiments, the manual force can be transmitted from the actuator 304 to the coupling 306 without the need for the previously described belt and connector, which can simplify the manual device 300 by reducing the number of moving parts.

FIG. 6 shows a perspective view of the mixing mounting 208 previously shown in FIGS. 2 and 3. The mixing mounting 208 can be mounted to and used together with any of the previously described manual devices 100, 200, 300. The mixing mounting 208 can include one or more container holders 232 that can each hold a container (e.g., the container 110). In embodiments such as shown in FIG. 6 the mixing mounting 208 can include two container holders 232 though any number of container holders 232 including only a single container holder are possible. Each container holder 232 can project angularly at an angle off of a longitudinal axis 234 of the mixing mounting 208. In embodiments, the angle can be less than 90 degrees. According to this configuration, each container holder 232 can mix the components of the solution contained within a container held by the respective container holder 232.

In embodiments, each container holder 232 define an opening 238 within an interior of the container holder 232. The opening 238 can have a diameter. In embodiments with more than one container holder 232, a diameter of the opening 238 of at least one container holder 232 can be equal to or different from a diameter of the opening 238 of another container holder 232. Each container holder 232 can be adjustable (e.g., can include a slit that can flex open, and/or can include flaps protruding towards the center of each container holder 232) such that the opening 238 of the container holder 232 can be increased and/or decreased to accommodate different sized containers.

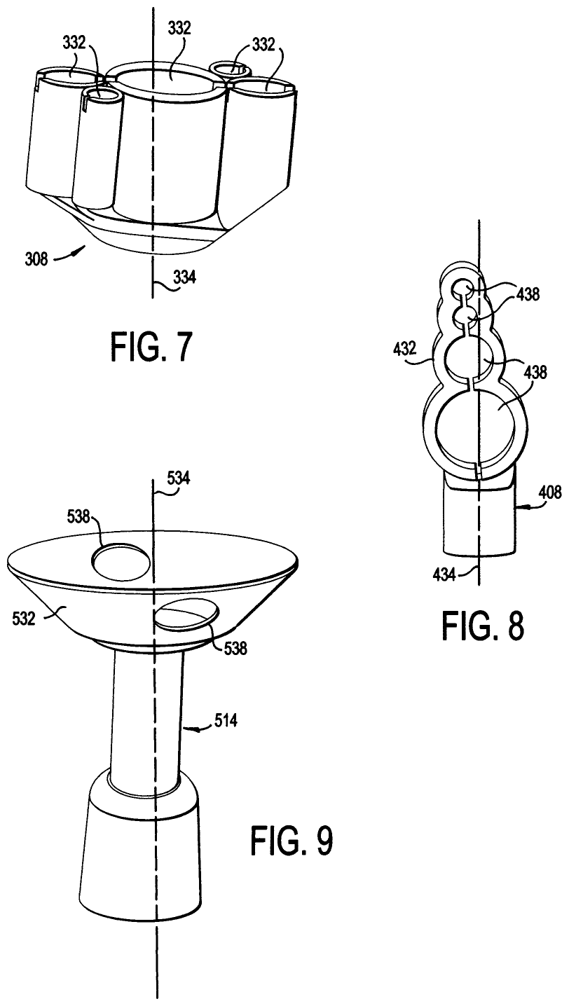

FIG. 7 shows a perspective view of another mixing mounting 308. The mixing mounting 308 can be mounted to and used together with any of the previously described manual devices 100, 200, 300. The mixing mounting 308 can include one or more container holders 332 that can each hold a container (e.g., the container 110). In embodiments such as shown in FIG. 7, the mixing mounting 308 can include five container holders 332 though any number of container holders 332 including only a single container holder are possible. Each container holder 332 can extend askew from a longitudinal axis 334 of the mixing mounting 308 to induce mixing of the components within the solution contained in the container when the mixing mounting 308 is rotated. Each container holder 332 can be tubes. In embodiments with more than one container holder 332, one or more of the container holders 332 can be sized differently (e.g., different dimeter, length, etc.) than one or more other container holders 332 to accommodate different sized containers.

FIG. 8 shows a perspective view of yet another mixing mounting 408. The mixing mounting 408 can be mounted to and used together with any of the previously described manual devices 100, 200, 300. The mixing mounting 408 can include a container holder 432 that defines multiple openings 438 that can each hold a container (e.g., the container 110). In embodiments such as shown in FIG. 8, the mixing mounting 408 can include four openings 438 though any number of openings 438, including only a single opening, are possible. The container holder 432 can extend angularly at an angle off of a longitudinal axis 434 of the mixing mounting 408 to induce mixing of the components of the solution contained within the container when the mixing mounting 408 is rotated. The angle can be less than 90 degrees. In embodiments with more than one opening 438, one or more of the openings 438 can be sized differently (e.g., different dimeter) than one or more other openings 438 to accommodate different sized containers.

FIG. 9 shows a perspective view of a separating mounting 514. The separating mounting 514 can be mounted to and used together with any of the previously described manual devices 100, 200, 300. The separating mounting 514 can include a container holder 532 that defines multiple openings 538 that can each hold a container (e.g., the container 110). In embodiments such as shown in FIG. 9, the separating mounting 514 can include two openings 538 though any number of openings 538, including only a single opening, are possible. The container holder 532 can extend angularly at an angle off of a longitudinal axis 534 of the separating mounting 514. For example, in embodiments such as shown in FIG. 9 the container holder 532 can define a bowl or cone shape circumscribing the longitudinal axis 534. The openings 538 can hold the containers at an angle of 90 degrees relative to the longitudinal axis 534 to separate components of a solution within the container when the separating mounting 514 is rotated. In embodiments with more than one opening 538, one or more of the openings 538 can be sized differently (e.g., different dimeter) than one or more other openings 538 to accommodate different sized containers

While certain implementations of the invention have been described, the present disclosure is not limited to these disclosed aspects. Additional modifications and improvements to the disclosure may be apparent to those skilled in the art. Moreover, the many features and advantages of the disclosure are apparent from the detailed specification, and thus, it is intended by the appended claims to cover all such features and advantages of the present disclosure which fall within the spirit and scope of the disclosure.

What is claimed is:

1. A manual system comprising:
a body;
an actuator that is configured to be manually actuated by a user; and
a coupling;
a mounting that is configured to mount to the coupling and that is configured to hold a container filled with a solution; and
a transmission within the body and operatively connected to the actuator and to the coupling,
wherein, when the coupling is connected to the mounting, when the mounting holds the container filled with the solution, and when the actuator is actuated by the user, the transmission transmits a manual force from the actuator to the coupling to rotate the coupling and the mounting and one of mix components of the solution or separate the components of the solution,
wherein the manual force applied to the actuator and transmitted to the coupling by the transmission is the only force actively applied by the manual system to the coupling to rotate the coupling.

2. The manual system of claim 1, wherein the manual system includes no electric motor that is configured to rotate the coupling.

3. The manual system of claim 1, wherein the mounting is removably connected to the coupling.

4. The manual system of claim 1, wherein the mounting is a mixing mounting, and
wherein the manual system further comprises a separating mounting that is interchangeable with the mixing mounting.

5. The manual system of claim 4, wherein the separating mounting is configured to hold the container filled with the solution, and
wherein, when the coupling is connected to the separating mounting, when the separating mounting holds the container filled with the solution, and when the actuator is actuated by the user, the transmission transmits the manual force from the actuator to the coupling to rotate the coupling and separate the components of the solution.

6. The manual system of claim 1, wherein the actuator is configured to impart a linear force of the manual force to the transmission, and
wherein the transmission is configured to convert the linear force to a rotational force.

7. The manual system of claim 1, wherein the actuator is configured to move between a first position and a second position, and
wherein a movement of the actuator from the first position to the second position inputs the manual force into the manual system.

8. The manual system of claim 7, wherein the actuator comprises a spring that biases the actuator in the first position.

9. The manual system of claim 1, wherein the transmission comprises a gear train.

10. The manual system of claim 1, wherein the transmission comprises a belt.

11. A manual device, the manual device comprising:
a body;
an actuator that is configured to be manually actuated by a user; and
a coupling configured to mount a mounting that holds a container filled with a solution; and
a transmission within the body and operatively connected to the actuator and to the coupling,
wherein, when the coupling is connected to the mounting, when the mounting holds the container filled with the solution, and when the actuator is actuated by the user, the transmission transmits a manual force from the actuator to the coupling to rotate the coupling and the mounting and one of mix components of the solution or separate the components of the solution,
wherein the manual force applied to the actuator and transmitted to the coupling by the transmission is the only force actively applied by the manual device to the coupling to rotate the coupling.

12. The manual device of claim 11, wherein the manual device includes no electric motor that is configured to rotate the coupling.

13. The manual device of claim 11, wherein the coupling is configured to removably mount the mounting.

14. The manual device of claim 11, wherein the mounting is a mixing mounting, and
wherein the coupling is configured to interchangeably mount the mixing mounting and a separating mounting.

15. The manual device of claim 14, wherein the separating mounting is configured to hold the container filled with the solution, and
wherein, when the coupling mounts the separating mounting, when the separating mounting holds the container filled with the solution, and when the actuator is actuated by the user, the transmission transmits the manual force from the actuator to the coupling to rotate the coupling and the separating mounting and performs a centrifuge of the solution.

16. The manual device of claim 11, wherein the actuator is configured to impart a linear force of the manual force to the transmission, and
wherein the transmission is configured to convert the linear force to a rotational force.

17. The manual device of claim 11, wherein the actuator is configured to move between a first position and a second position, and
wherein a movement of the actuator from the first position to the second position inputs the manual force into the manual device.

18. The manual device of claim 17, wherein the actuator comprises a spring that biases the actuator in the first position.

19. The manual device of claim 11, wherein the transmission comprises a gear train.

20. The manual device of claim 11, wherein the transmission comprises a belt.
